(19) United States
(12) Patent Application Publication
(10) Pub. No.: US 2013/0234516 A1
(43) Pub. Date: Sep. 12, 2013

(54) ELECTRICITY GENERATION CONTROLLER, ELECTRICITY GENERATION CONTROL SYSTEM, AND ELECTRICITY GENERATION CONTROL METHOD

(71) Applicant: PANASONIC CORPORATION, Osaka (JP)

(72) Inventor: Ryota YUKIZANE, Fukuoka (JP)

(73) Assignee: PANASONIC CORPORATION, Osaka (JP)

(21) Appl. No.: 13/788,837

(22) Filed: Mar. 7, 2013

(30) Foreign Application Priority Data
Mar. 9, 2012 (JP) 2012-053534

(51) Int. Cl. G05F 3/08

(52) U.S. Cl. CPC G05F 3/08
USPC 307/43; 323/304

(57) ABSTRACT

An electricity generation controller for controlling an electrical energy production of a photo voltaic panel is provided. The electricity generation controller includes a control section that controls an output of the photo voltaic panel within a first range, a signal processing section that processes a predetermined signal., and an output range change section that changes an output range of the photo voltaic panel controlled by the control section from the first range to a second range in accordance with the predetermined signal processed by the signal processing section, wherein the second range is broader than the first range.

### BACKGROUND

1. Technical Field

The present invention relates to an electricity generation controller, an electricity generation control system, and an electricity generation control method.

2. Background Art

Photo voltaic power generation for converting sunlight energy into electric energy by utilization of a photo voltaic panel. (PV panel) has hitherto become pervasive. In relation to photo voltaic power generation, waste materials, water discharge, noise, vibrations, or the like, do not occur during power generation, and utilizing photo voltaic power generation as an emergency power supply is also expected. For these reasons, photo voltaic power generation has particularly received attention in recent years.

PV panels are often installed outdoors, such as on a rooftop, in order to increase an electrical energy production. For this reason, the PV panels are vulnerable to direct influence of natural phenomena, like winds, rain, snow, and other factors. A longstanding buildup of the influence of natural phenomena and other factors sometimes causes a breakdown in the PV panels.

A technique described in connection with JP-A-2007-311487 has been known as a method for carrying out a fault diagnosis of the PV panels. JP-A-2007-311487 discloses measuring a current-voltage characteristic of the PV panels, converting the current-voltage characteristic into a base condition, and determining which one of a plurality of standard characteristics most closely resembles the base condition. The fault diagnosis of the PV panels can thereby be performed in detail.

However, according to the technique described in connection with JP-A-2007-311487, a worker must go to an installation site of the PV panels and conduct a fault diagnosis by directly connecting a characteristic evaluation apparatus to the PV panels, which involves consumption of much time In particular, in a case where the PV panels are installed on a rooftop, the diagnosis turns into high-lift, high-voltage work fraught with danger. Moreover, since the worker must go to the mount site of the PV panels, delay is likely to arise in finding a fault, which causes a loss in electrical energy production from the instant of occurrence of a fault up to the instant of finding the fault.

### SUMMARY

The present invention provides an electricity generation controller, an electricity generation control system, and an electricity generation control method that make it possible to carry out an easy fault diagnosis of photo voltaic panels.

An aspect of the present invention provides an electricity generation controller for controlling an electrical energy production of a photo voltaic panel, the electricity generation controller including: a control section that controls an output of the photo voltaic panel within a first range; a signal processing section that processes a predetermined signal; and an output range change section that changes an output range of the photo voltaic panel controlled by the control section from the first range to a second range in accordance with the predetermined signal processed by the signal processing section, wherein the second range is broader than the first range.

Another aspect of the present invention provides an electricity generation control system including a plurality of electricity generation controllers for controlling electrical energy productions of a plurality of serial- or parallel-connected photo voltaic panels, wherein each of the electricity generation controllers includes: a control section that controls an output of the photo voltaic panel within a first range; a signal processing section that processes a predetermined signal; and an output range change section that changes an output range of the photo voltaic panel controlled by the control section from the first range to a second range in accordance with the predetermined signal processed by the signal processing section, wherein the second range is broader than the first range.

Still another aspect of the present invention provides an electricity generation control method for controlling an electrical energy production of a photo voltaic panel, the method including: controlling an output of the photo voltaic panel within a first range; processing a predetermined signal; and changing an output range of the photo voltaic panel from the first range to a second range in accordance with the processed predetermined signal, wherein the second range is broader than the first range. The present invention enables easy performance of fault diagnosis of a photo voltaic panel.

### BRIEF DESCRIPTION OF THE DRAWINGS

In the accompanying drawings:

FIG. 1 is a schematic block diagram showing a photo voltaic system according to embodiments of the present invention;

FIG. 2 is a block diagram showing an example of a configuration of a panel controller (a slave unit) according to the embodiments of the present invention;

FIG. 3 is a block diagram showing an example of a configuration of a power conditioner with a built-in panel controller (a master unit) according to the embodiments of the present invention;

FIG. 4 is a graph showing an example of an I-V characteristic of a PV panel achieved during MPPT control operation in the embodiments of the present invention;

FIG. 5 is a graph showing an example of an I-V characteristic of the PV panel achieved during fault diagnostic processing in the embodiments of the present invention;

FIG. 6 is a flowchart showing a first example of operation achieved during fault diagnostic processing performed by the panel controller (the slave unit) according to the first embodiment of the present invention;

FIG. 7 is a flowchart showing a second example of operation achieved during the fault diagnostic processing performed by the panel controller (the slave unit) according to the first embodiment of the present invention;

FIG. 8 is a flowchart showing an example of operation achieved during fault diagnostic processing performed by the panel controller (the master unit) according to the first embodiment of the present invention;

FIG. 9 is a sequence diagram showing an example of operation achieved during cooperative diagnostic processing performed in a photo voltaic system of a second embodiment of the present invention; and

FIG. 10 is an enlarged view of surroundings of a PV string in the photo voltaic system shown in FIG. 1.

### DETAILED DESCRIPTION

Embodiments of the present invention are hereunder described by reference to the drawings.

### First Embodiment

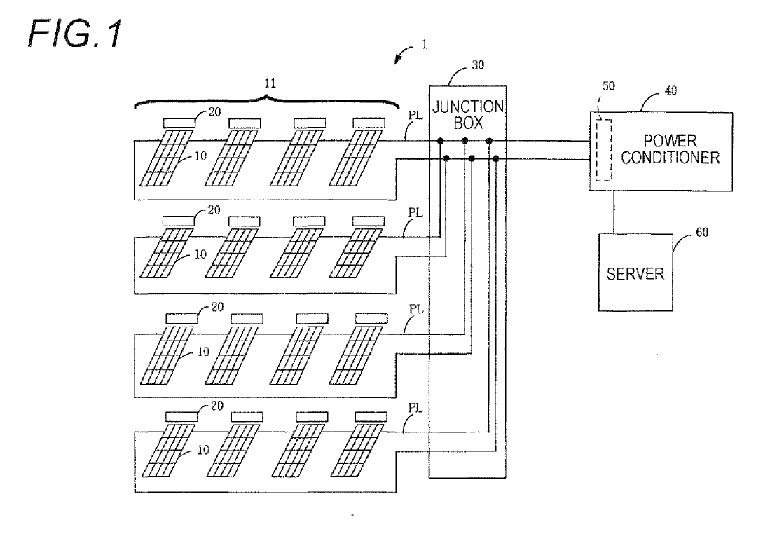

FIG. 1 is a schematic view of an example of a configuration of a photo voltaic system 1 according to a first embodiment of the present invention. The photo voltaic system 1 is equipped with photo voltaic (PV) panels 10, panel controllers 20, a junction box 30, a power conditioner 40, a panel controller 50, and a server GO. The photo voltaic system is an example of a power generation control system.

The individual PV panel 10 is a panel that includes a photo voltaic battery that converts light energy into electric power by means of a photoelectric effect. The PV panel 10 can be also a photo voltaic cell that is a photo voltaic elementary substance or a photo voltaic battery module that is a combination of a plurality of photo voltaic batteries. The PV panels 10 are connected in series to a power line PL. A one-to-one correspondence exists between the PV panel 10 and the panel controller 20.

In the embodiment shown in FIG. 1, the PV panels 10 are connected in series to each other by way of the power line FL, thereby making up a photo voltaic string (PV string) 11. Further, the photo voltaic strings 11 are connected in shunt with each other in the junction box 30 by way of the power lines PL, thereby making up a photo voltaic array (PV array). Although the PV string is made by connecting four PV panels 10 in series, the number of PV panels is not limited to four. Further, although the PV array is constituted by connecting four PV strings in parallel, the number of PV strings is not limited to four.

The panel controller 20 controls an electrical energy production of the PV panel 10. The panel controller 20 inputs generated electrical power of the corresponding PV panel 10 and controls in such a manner that the generated electrical power comes to desired electrical power. Desired electrical power is determined from a control signal pertinent to electrical power generation from the power conditioner 40 (the signal including information, such as a voltage and an electrical current). Desired electrical power sometimes varies from one panel controller 20 to another according to insolation conditions, and the like. Specifically, the panel controller 20 controls an electrical energy production of the PV panel 10. Further, the panel controller 20 and the panel controller 50 communicate with each other by way of the power line PL.

Moreover, the panel controller 20 operates as a slave unit of the panel controller 50. The panel controller 20 communicates with another panel controller 20 or the panel controller 50 by means of wired or wireless communication. Also, both wired and wireless communication can be used. In the case of wired communication, communication is established by use of for instance, the power line PL and by utilization of a communications frequency band of for instance, 2 to 30 MHz. In the case of wireless communication, a communications frequency band of for instance, 1.9 GHz, is utilized.

The panel controller 20 also performs processing pertinent to Maximum Power Point Tracking (hereinafter also referred to simply as “MPPT control”). MPPT control is one for maximizing electrical power generated by means of photo voltaic power generation in the entire photo voltaic system 1. The panel controller 20 also performs processing pertinent to fault diagnostic processing for determining if the PV panel 10 is faulty.

The junction box 30 collectively connects the power lines PL, each of which serves as wiring for a single PV string 11. made by connecting the plurality of PV panels 10 in series, to the power conditioner 40. The junction box 30 includes terminals for connections with the power lines PL, switches used for a check or maintenance, a lighting protection element, a blocking diode for inhibiting backflow of electricity, and others.

The junction box 30 can be also combined with the power conditioner 40 into a single unit. Alternatively, the junction box 30 can be omitted.

The power conditioner 40 converts, into AC power, DC power equivalent to generated electrical power of the individual PV panel 10 output from the panel controller 20. The power conditioner 40 is connected to; for instance, a distribution board (not shown).

The power conditioner 40 performs processing pertinent to MPPT control. MPPT control is one for maximizing electrical power generated by means of photo voltaic power generation in the entire photo voltaic system 1. The power conditioner 40 also performs processing pertinent to fault diagnostic processing for determining if the PV panel 10 is faulty.

The panel controller 50 operates as a master unit for the plurality of panel controllers 20. The panel controller 50 also performs processing pertinent to fault diagnostic processing. The panel controller 50 receives; for instance, values measured by the panel controller 20 (e.g., a measured current value, a measured voltage value, and measured power) from the panel controller 20 and monitors the electrical energy production of the PV panel 10 at all times.

Specific restrictions are not imposed on the installation site of the panel controller 50. For instance, the panel controller 50 can be installed in the power conditioner 40 or in the junction box 30 or can be connected to any arbitrary point on the power line PL. Furthermore, when wireless communication is established between the panel controller 50 and the panel controllers 20, the essential requirement for the panel controller 50 is to be placed at any location connected to a communication line. By way of example, the panel controller 50 is accommodated in the power conditioner 40 in FIG. 1.

The server 60 communicates with another communication device, like the panel controller 50, thereby acquiring, storing, and analyzing data. The panel controller 50 performs processing pertinent to faulty diagnostic processing.

The server 60 can be a server installed in a locale that is the property of an owner of the PV panels 10 or a server installed at a remote site that is a property of a manufacturer or a maintenance service provider of the PV panels 10.

An example of a detailed configuration of the panel controller 20 is now described.

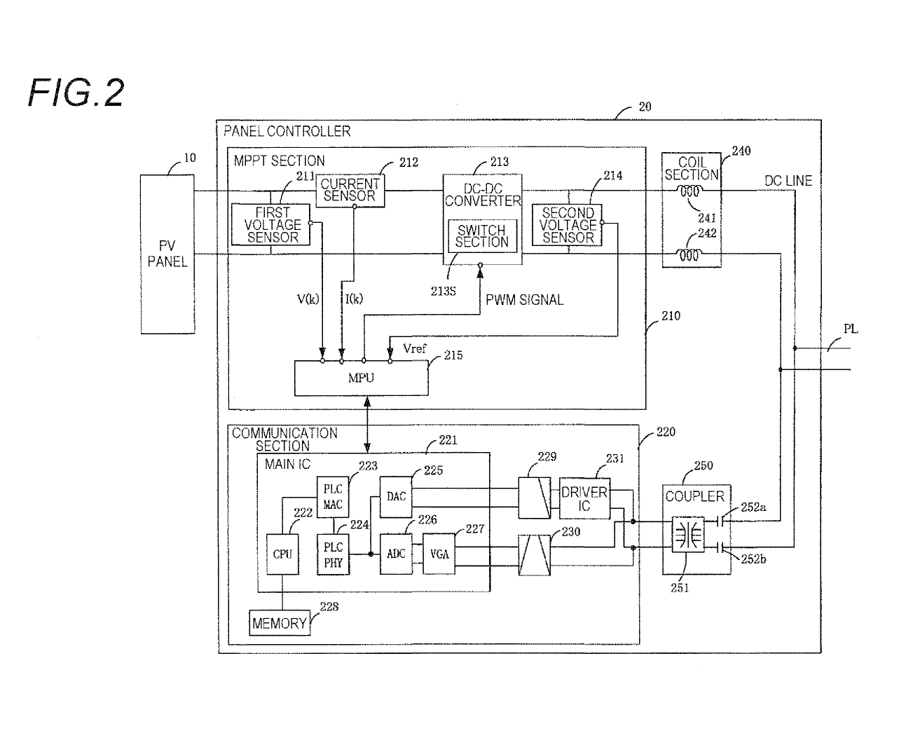

FIG. 2 is a block diagram showing an example of the configuration of the panel controller 20. The panel controller 20 is equipped with an MPPT section 210, a communication section 220, a coil section 240, and a coupler 250.

The MPPT section 210 performs MPPT control. Further, the MPPT section 210 is also connected in series to the corresponding PV panel 10 and controls an inter-terminal voltage of the PV panel 10 in such a way that the electrical power generated by the PV panel 10 becomes maximum. A detailed configuration of the MPPT section 210 will be described later.

The MPPT section 210 performs fault diagnostic processing of the PV panel 10 connected to the panel controller 20. Fault diagnostic processing will be described in detail later.

The communication section 220 is connected in parallel to the PV panel 10 and sends a communication of various information by way of the power line PL. For instance, the communication section 220 sends to the power conditioner 40 a communication of a control signal pertaining to electrical power generation of the PV panel 10. A detailed configuration of the communication section 220 will be described later.

The coil section 240 is connected in series to the PV panel 10, and coils 241 and 242 are provided for a pair of power lines PL, respectively. The coil section 240 acts as a first filter section that blocks a frequency band for transmission of a control signal and permits passage of a frequency band for transmission of DC power. The coil section 240 makes it possible to block a signal of a high frequency band which is a signal band, thereby preventing transmission of the control signal to the PV panel 10.

The coupler 250 is connected in series to the communication section 220 and made up of a coil transformer 251 and coupling capacitors 252a and 252b. The coupler 250 acts as a second filter section that permits passage of a frequency band for transmission of a control signal and blocks a frequency band for transmission of DC power.

The coupler 250 makes it possible to prevent application of the DC voltage to the communication section 220 (i.e., cut DC components) and permit passage of a signal in a signal band for transmission of the control signal.

The coupling capacitors 252a and 252b also act as noise filters. Accordingly, noise transmitted from the PV panel 10 to the panel controller 20 and switching noise that occurs in a DC-DC converter 213 of the MPPT section 210 can be prevented from being transmitted to the communication section 220.

The coupler 250 is exemplified as being made up of the capacitors and the transformer but can be embodied by another configuration.

When the panel controller 20 performs wireless communication, the coupler 250 is unnecessary. By way of example, FIG. 2 shows a presumption that the panel controller 20 performs communication by way of the power line PL.

The MPPT section 210 is equipped with a first voltage sensor 211, a current sensor 212, the DC-DC converter 213, a second voltage sensor 214, and a microprocessor (MPU: Micro Processing Unit) 215.

The first voltage sensor 211 detects a voltage (inter-terminal. voltage) output from the PV panel 10 connected to the panel controller 20. A voltage detected by the first voltage sensor 211 is hereinbelow referred to also as a first detected voltage.

The current sensor 212 detects an electric current output from the PV panel 10 connected to the panel controller 20. An electric current detected by the current sensor 212 is hereinbelow referred to also as a first detected current.

The DC-DC converter 213 is equipped with a switch section 213S having a switching element for power conversion purpose. The switch section 2135 is toggled between ON and OFF at correct time, thereby controlling a power supply fed, as a power source, from the PV panel 10 by way of the power line PL.

The DC-DC converter 213 receives as an input a voltage output from the PV panel 10 connected to the panel controller 20 and transforms the input voltage by use of the switch section 2135. Further, the switch section 213S is controlled ON/OFF in accordance with a PWM (Pulse Width Modulation) signal from the MPU 215.

The second voltage sensor 214 detects a voltage (a transformed voltage) output from the DC-DC converter 213. A voltage detected by the second voltage sensor 214 is hereinbelow referred to also as a second detected voltage.

The MPU 215 controls the DC-DC converter 213 in such a way that the first detected voltage or the second detected voltage comes to a predetermined voltage value. For instance, the “predetermined voltage” is a voltage value that is indicated by a control signal received by the communication section 220. Further, control of the DC-DC converter 213 is controlling a duty ratio of the switch section 2135 in the DC-DC converter 213.

The communication section 220 is equipped with a main IC (Integrated Circuit) 221, memory 228, a low-pass filter (LPF) 229, a band pass filter (BPF) 230, and a driver IC 231.

The main IC 221 is equipped with a CPU (Central Processing Unit) 222 and PLC-MAC (Power Line Communication Media Access Control layer) block 223. In addition, the main IC 221 is equipped with a PLC-PHY (Power Line Communication-Physical layer) block 224 and a DA converter (DAC: DIA converter) 225. The main IC 221 is equipped with an AD converter (ADC: AID converter) 226 and a variable amplifier (VAG: Variable Gain Amplifier) 227.

The main IC 221 is an integrated circuit that functions as a control circuit for effecting a power line communication. The main IC 221 is connected to the MPU 215 of the MPPT section 210 and exchanges data by means of serial communication.

For instance, an 8-bit RISC (Reduced Instruction Set Compute) processor is implemented in the CPU 222. The PLC-MAC block 223 manages a MAC layer (Media Access Control layer) of a transmission signal and that of a received signal. The PLC-PHY block 224 manages a PRY layer (Physical layer) of a transmission signal and that of a received signal.

The DA converter 225 converts a digital signal into an analogue signal. The AD converter 226 converts an analogue signal into a digital signal. The variable amplifier 227 amplifies a signal input from the BPF 230.

The memory 228 is a semiconductor storage device, like RAM (Random Access Memory) and ROM (Read Only Memory). The LPF 229 permits transmission of a low frequency component of the signal input from the DA converter 225 and blocks the other components. The BPF 230 permits transmission of a predetermined frequency component of a signal input from the coupler 250 and blocks the other components. The diver IC 231 is an IC for activating predetermined equipment.

The CPU 222 controls operation of the PLC-MAC block 223 and operation of the PLC-PRY block 224 by utilization of data stored in the memory 228, as well as controlling the entirety of the communication section 220.

The communication section 220 generally performs communication as follows. Data to be transmitted, which are stored in the memory 228 or the like, are transmitted to the main IC 221. The main IC 221 subjects the data to digital signal processing, thereby generating a digital transmission signal. The thus-generated digital transmission signal is converted into an analogue signal by the DA converter 225 and output to the power line PL by way of the low-pass filter 229, the driver IC 231, and the coupler 250.

The signal received from the power line PL is delivered to the band pass filter 230 by way of the coupler 250. After being subjected to gain control by the variable amplifier 227, the signal is converted into a digital signal by the AD converter 226. The thus-converted digital signal is subjected to digital signal processing, to thus be converted into digital data. The thus-converted digital data are stored in; for instance, the memory 228.

An example of digital signal processing implemented by the main IC 221 is now described. The communication section 220 uses a single carrier signal as a transmission signal. The communication section 220 converts data to be transmitted into a single carrier transmission signal and outputs the thus-converted transmission signal. Further, the communication section 220 processes a single carrier received signal, to thus convert it into received data. Digital signal processing for these converting operations is primarily performed by the PLC-PHY block 224.

An example of a detailed configuration of the power conditioner 40 is now described.

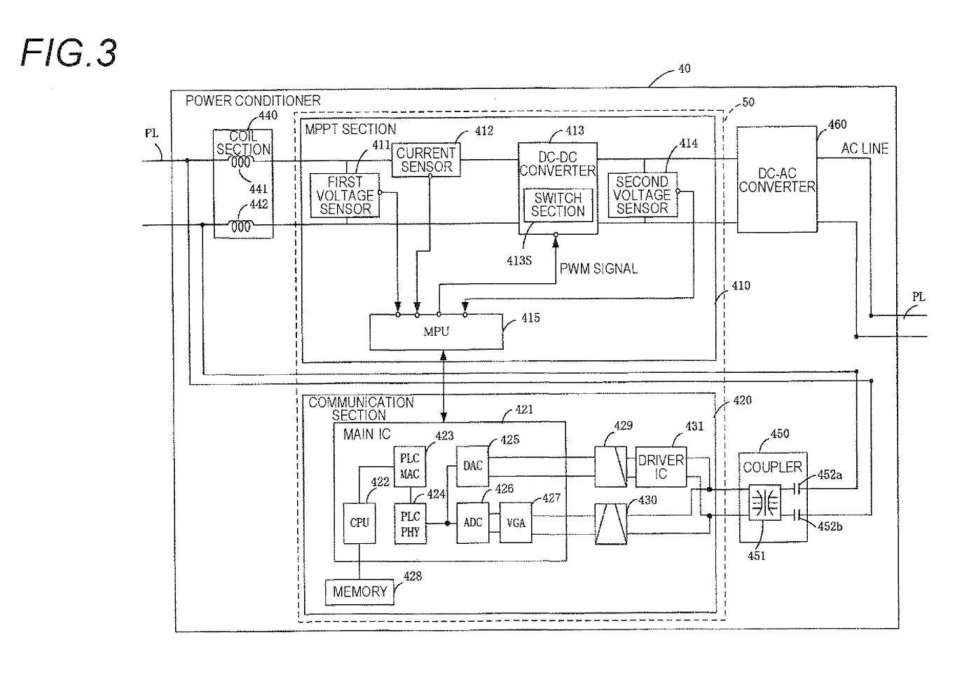

FIG. 3 is a block diagram showing an example of a configuration of the power conditioner 40. The power conditioner 40 is equipped with an MPPT section 410, a communication section 420, a coil section 440, a coupler 450, and a DC-AC converter 460. In the example shown in FIG. 3, the MPPT section 410 and the communication section 420 belong to the panel controller 50.

Although the MPPT section 410 is different from its counterpart MPPT section 210 of the panel controller 20 by only reference numeral 200, they have the same configuration and function, and therefore their explanations are omitted. A detailed internal configuration (e.g., an MPU 415) of the MPPT section 410 also differs from the detailed configuration (e.g., the MPU 215) of its counterpart MPPT section 210 of the panel controller 20 by only reference numeral 200. However, since they have the same configuration and function, their explanations are omitted.

A voltage detected by a first voltage sensor 411 is hereinbelow referred to also as a third detected voltage. A voltage detected by a second, voltage sensor 414 is hereinbelow referred to also as a fourth detected voltage. Moreover, an electric current detected by a current sensor 412 is hereinbelow referred to also as a second detected current.

Although the communication section 420 is different from its counterpart communication section 220 of the panel controller 20 by only reference numeral 200, they have the same configuration and function, and therefore their explanations are omitted. A detailed internal configuration (e.g., a CPU 422) of the communication section 420 also differs from the detailed configuration (e.g., the CPU 222) of its counterpart communication section 220 of the panel. controller 20 by a difference of only reference numeral 200. However, since they have the same configuration and function, their explanations are omitted.

Although the coil section 440 is different from its counterpart coil section 240 of the panel controller 20 by only reference numeral 200, they have the same configuration and function, and therefore their explanations are omitted.

Although the coupler 450 is different from its counterpart coupler 250 of the panel controller 20 by only reference numeral 200, they have the same configuration and function, and therefore their explanations are omitted.

The DC-AC converter 460 converts, into AC power, DC power equivalent to generated electrical power of the individual PV panel 10 output from the panel controller 20.

Incidentally, even when the power conditioner 40 is not accommodated in the panel controller 50, the power conditioner 40 is equipped with the MPPT section 410 and the communication section 420.

The server 60 is equipped with component parts analogous to component parts of a common server. For instance, the server 60 is equipped with a communication section having a wired or wireless communication function, and the server 60 communicates with another communications device, such as the panel controller 50.

The server 60 has a memory, a CPU, and the like. The CPU exercises a program stored in the memory, whereby a predetermined function can be implemented. For instance, the server 60 determines, from information from the panel controller 20, if the PV panel 10 is faulty.

An example of MPPT control of the photo voltaic system 1 is now described.

The panel controller 20 and the power conditioner 40 exchange data for MPPT control to each other by means of communication.

First, the communication section 420 of the power conditioner 40 receives from the panel controller 20 a control signal including voltage information and current information by way of the power line PL. The voltage information is information about the first detected voltage or the second detected voltage. The current information is information about the first detected current.

Subsequently, the communication section 420 of the power conditioner 40 calculates a voltage value and a current value that are optimum for the PV panel 10 from the voltage information and the current information about the panel controller 20. The voltage value and the current value, which are optimum for MPPT control, correspond to a voltage value and a current value of the individual PV panel 10 at which overall electric power generated by the plurality of PV panels 10 becomes maximum. The optimum voltage value and the optimum current value are dependent on the orientation of the PV panel 10, the installation site of the PV panel 10, and the weather, and therefore sometimes vary from one PV panel 10 to another.

Subsequently, the communication section 420 of the power conditioner 40 generates a control signal by incorporating the thus-calculated voltage and current values for the PV panel 10 into optimum voltage information and optimum current information. The communication section 420 transmits the control signal to the panel controller 20 corresponding to the PV panel 10 by way of the power line PL. The communication section 420 can also calculate optimum electric power from the optimum voltage information and the optimum current information, incorporate the thus-calculated optimum electric power into the optimum current information, incorporate the optimum power information into the control signal, and transmit the control signal to the panel controller 20.

Subsequently, the communication section 220 of the panel controller 20 receives the optimum voltage information and the optimum current information from the power conditioner 40. The MPPT section 210 of the panel controller 20 controls ON/OFF the switch section 213S of the DC-DC converter 213 such that a voltage value incorporated in the received optimum voltage information and a current value incorporated in the received optimum current information are acquired.

Specifically, the MPU 215 controls ON/OFF the switch section 2135 such that the first detected voltage or the second detected voltage comes to the voltage value incorporated in the optimum voltage information. The MPU 215 can also control ON/OFF the switch section 213S such that the first detected current comes to the current value incorporated in the optimum current information.

Since an output side of the DC-DC converter 213 is presumed to be more affected by noise than is an input side of the DC-DC converter 213, the first detected voltage is preferable as the optimum voltage.

The power conditioner 40 is herein presumed to provide the panel controller 20 with information about the optimum voltage and current. The MPU 215 of the panel controller 20 instead can also determine, for itself, optimum voltage information and optimum current information from the first detected voltage and the second detected voltage. Further, the power conditioner 40 can also perform MPPT control on the basis of the third detected voltage, the fourth detected current, or the second detected voltage, all of which have been detected by the power conditioner 40.

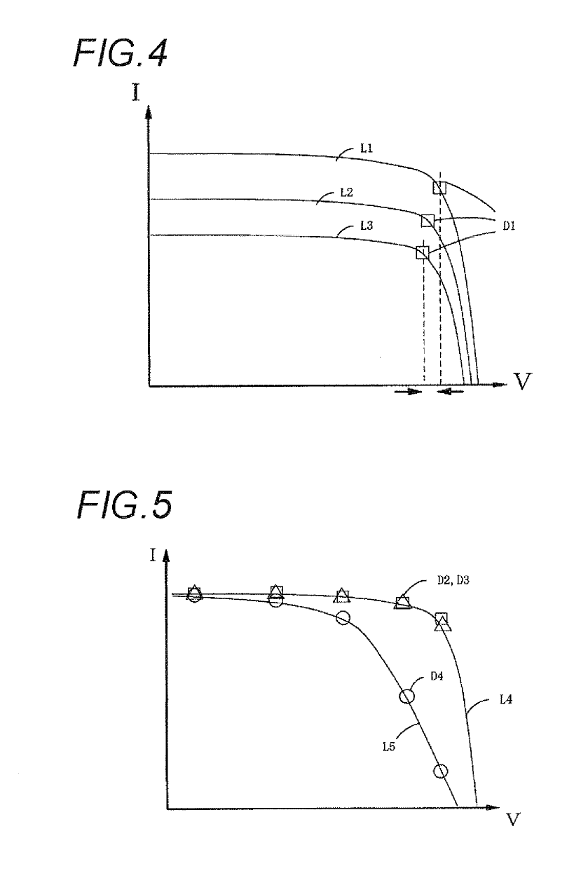

FIG. 4 is a graph showing an example of an output voltage characteristic and an output current characteristic (an I-V characteristic) of the PV panel 10 achieved during MPPT control operation. The I-V characteristic of the PV panel 10 changes according to an amount of sunlight as indicated by lines L1 to L3 shown in FIG. 4. The lines ordered in increasing sequence of sunlight quantity are L1, L2, and L3. When performing MPPT control, the panel controller 20 or the power conditioner 40 controls the output voltage and the output current of the individual PV panel 10 such that the electric power becomes maximum according to the amount of sunlight. In FIG. 4, an operating point of a control result is designated by symbol D1.

Fault diagnostic processing of the photo voltaic system 1 is now described.

Fault diagnostic processing is performed by use of the MPPT section 210 of the panel controller 20 or the MPPT section 410 of the power conditioner 40. During fault diagnostic processing, a determination is made, on the basis of the I-V characteristic acquired at the operating point of the PV panel 10, as to whether or not the individual PV panel 10 is faulty.

The following two; for instance, are conceivable as a method for acquiring an I-V characteristic of the PV panel 10 used in fault diagnostic processing. During fault diagnostic processing, the MPPT section 210 of the panel controller 20 can broadly acquire various operating points other than the maximum operating point.

Under a first acquisition method, the MPPT section 210 of the panel controller 20 sequentially changes the operating point of the PV panel 10 to be diagnosed, thereby acquiring an I-V characteristic of the PV panel 10 at each operating point.

Under a second acquisition method, the MPPT section 410 of the power conditioner 40 sequentially changes an input voltage and an input current of the power conditioner 40. Operating points of the respective PV panels 10 change in conjunction with the changes. The MPPT section 210 of the panel controller 20 acquires an I-V characteristic of the individual PV panel 10 at its operating point.

The output voltage or the output current of the PV panel 10 acquired by the panel controller 20 corresponds to the first detected voltage, the second detected voltage, or the first detected current. Moreover, the number of operating points controlled by the panel controller 20 is not particularly limited. A more accurate fault diagnosis can be practiced by acquisition of I-V characteristics at a larger number of operating points.

The panel controller 20 can also acquire the I-V characteristic of the PV panel a number of times by changing the date and time for acquiring the I-V characteristic and collect a statistic on the I-V characteristics. For instance, the panel controller 20 can also use an average of the plurality of thus-acquired I-V characteristics for fault diagnostic processing. The system can thereby address various insolation conditions and environmental conditions, such as a cloudy environment where the first characteristic was acquired, so that occurrence of an erroneous determination can be prevented.

The server 60 collects and stores the information about the I-V characteristics of the PV panels 10 acquired by the respective panel controllers 20 by way of the panel controller 50. Specifically, voltage and current information stored in the server 60 include at least one of pieces of information about the first detected voltage, the second detected voltage, and the first detected current.

The server 60 determines, from the I-V characteristic of the PV panel 10 acquired from the panel controller 20, whether or not the PV panel 10 is faulty.

The server 60 stores the I-V characteristic of the PV panel 10 on a per-panel basis and calculates a difference (e.g., a divergence) between the I-V characteristic of one predetermined PV panel 10 and the I-V characteristic of another PV panel 10. When the thus-calculated difference is a predetermined level or more, the server 60 can determine that the PV panel is faulty.

For instance, the server 60 previously retains information about an I-V characteristic of the PV panel 10 owned by the manufacturer (i.e., information about an I-V characteristic acquired in normal conditions) and compares the I-V characteristic for the normal conditions with the I-V characteristic acquired from the panel controller 20. If a comparison result shows a difference of predetermined level or more, the server 60 can determine that the PV panel is faulty.

For instance, the server 60 stores information about the I-V characteristic of the PV panel that was determined to be faulty in the past and compares the I-V characteristic with the I-V characteristic acquired from the panel controller 20. When the comparison result shows a predetermined level of similarity or more, the server 60 can determine that the PV panel is faulty.

Further, the server 60 can also cause a display device for displaying stored data on a Web screen to display information about the I-V characteristic and a P (power)-V (voltage) characteristic of the PV panel 10. The server 60 can calculate electric power from the first detected voltage or the second detected voltage and the first detected current. The server 60 can have the display device, or the display device can be a separate one. Visualizing the characteristics of the PV panels 10 further facilitate fault diagnosis.

When determining, on the basis of a result of fault diagnostic processing, that the PV panel 10 is faulty, the server 60 can report it to a user by use of the Web screen, an e-mail, voice, or the like. The user means the proprietor, manufacturer, or maintenance service provider of the PV panel 10 that is diagnosed as being faulty.

A specific example of fault diagnostic processing is now described.

FIG. 5 is a graph showing an example of the I-V characteristic of the PV panel 10 achieved during fault diagnostic processing. FIG. 5 shows respective operating points sequentially changed by means of fault diagnostic processing. When compared with the I-V characteristic that is shown in FIG. 4 and achieved during MPPT control, a distribution range of operating points D3 and D4 achieved during fault diagnostic processing can be understood to be broad. During fault diagnostic processing, the distribution range of the operating points can be intentionally broadened.

The sever 60 previously retains in its internal memory; for instance, information about an operating point distribution of the PV panel 10 achieved in normal conditions. When determining that a divergence of predetermined standard level or more exists between an operating point distribution D2 achieved in normal conditions and the operating point distributions D3 and D4 acquired in fault diagnostic processing, the server 60 determines that the PV panel 10 is faulty. Fault diagnostic processing is carried out for each PV panel 10.

The line L4 shown in FIG. 5 designates an I-V characteristic of the PV panel 10 acquired at a predetermined amount of sunlight and in normal conditions (i.e., nonfaulty conditions). When the sever 60 acquires from the panel controller 20 information about operating points D3 designated by solid triangles in FIG. 5, the respective operating points D3 are aligned to the line L4. Accordingly, when acquiring information about the respective operating points D3, the server 60 determines that the PV panel 10 is nonfaulty.

In the meantime, when the server 60 acquired from the panel controller 20 the respective operating points D4 designated by solid circles in FIG. 5, some of the operating points D4 are away from the line L4. Therefore, when acquiring information about the respective operating points D4 and when the line L5 that is a locus passing through the respective operating points D4 diverges from the line L4 by a predetermined standard distance or more, the sever 60 determines that the PV panel 10 is faulty.

Explanations are now given to timing at which fault diagnostic processing is commenced.

Conceivable timing for commencing fault diagnostic processing is; for instance, manual initiation of fault diagnostic processing. Fault diagnostic processing thus commenced is also called manual diagnosis. In addition, for instance, another conceivable way is to commence fault diagnostic processing on the basis of preset information. Fault diagnostic processing thus commenced is also called automatic diagnosis.

In relation to manual diagnosis, the photo voltaic system 1 commences fault diagnostic processing by detection of for instance, pressing a physical diagnosis button provided on any of the devices or a diagnosis button displayed in the Web screen. For instance, the panel controller 50 detects pressing the diagnosis button and commands commencement of fault diagnostic processing. The device equipped with the physical diagnosis button includes; for instance, the panel controller 50, the power conditioner 40, or another dedicated terminal.

In relation to automatic diagnosis, for instance, any of the devices in the photo voltaic system 1 previously retains information about a time to commence fault diagnostic processing and commences fault diagnostic processing at the date and time corresponding to the time information.

For instance, the panel controller 20 retains scheduled information and commands commencement of fault diagnostic processing when an unillustrated timer detects a coincidence with, a scheduled date and time. The time information includes; for instance, a time interval at which fault diagnostic processing is performed and information about a date and time to perform fault diagnostic processing.

Moreover, in relation to automatic diagnosis, the photo voltaic system 1 commences fault diagnostic processing on the basis of for instance, information about power generation of the PV panel 10.

For instance, when an electrical energy production of a predetermined PV panel 10 is continually lower than electrical energy productions of the other PV panels 10, the photo voltaic system 1 commences fault diagnostic processing of the predetermined PV panel 10.

Moreover, the electrical energy production of the PV panel 10 is stable or greater than a predetermined level, the photo voltaic system 1 commences fault diagnostic processing. A determination as to whether or not the electrical energy production is stable can be rendered by monitoring the first detected voltage, the second detected voltage, or the first detected current stored in the server 60 and on the basis of a determination as to whether or not a variation falls within a predetermined range. When the variation falls within the predetermined range, the electrical energy production is determined to be stable. Accuracy of fault diagnosis can thereby be enhanced.

Aside from manual diagnosis and automatic diagnosis, the photo voltaic system 1 can also commence fault diagnostic processing at initiation of the power conditioner 40, the panel controller 50, or the panel controller 20.

When the power of the power conditioner 40 or the panel controller 20 is switched from OFF to ON, the power conditioner 40 or the panel controller 20 commands commencement of MPPT control in order to generate electric power at the maximum power operating point. During MPPT control, the operating point of the PV panel 10 is changed primarily to a point that is expected to be a maximum electrical power point. The operating point is usually changed in sequence from the maximum value side of the range of the voltage output from the PV panel 10 during MPPT control. Accordingly, as can be comprehended by reference to FIG. 4, the amount of shift in operating point of the PV panel 10 does not increase much.

When fault diagnostic processing is performed at initiation of the power conditioner 40 or the panel controller 20, fault diagnostic processing is commenced along with MPPT control. Specifically, the panel controller 20 shifts the voltage from the maximum value side of the output voltage of the PV panel 10, which is a target of fault diagnosis, not to a vicinity of the maximum electrical power operation point but further up to the minimum value side, thereby acquiring an I-V characteristic at respective operating points over the broad range of the PV panel 10.

Such operation of the power conditioner 40, the panel controller 50, or the panel controller 20 at initiation is likewise applicable to a reset (i.e., a restart), as well. Resetting of the power conditioner 40 or the panel controller 20 is commanded by; for instance, the panel controller 50.

The device that commanded commencement of manual diagnosis, automatic diagnosis, or fault diagnostic processing for initiation or reset generates a diagnostic operation request for requesting commencement of fault diagnostic processing. When the device is other than the panel controller 20, a diagnostic operation request is transmitted to the panel controller 20 corresponding to the PV panel 10 that is a target of fault diagnosis.

Next, an example of operation of the fault diagnostic processing performed by the photo voltaic system 1 is described.

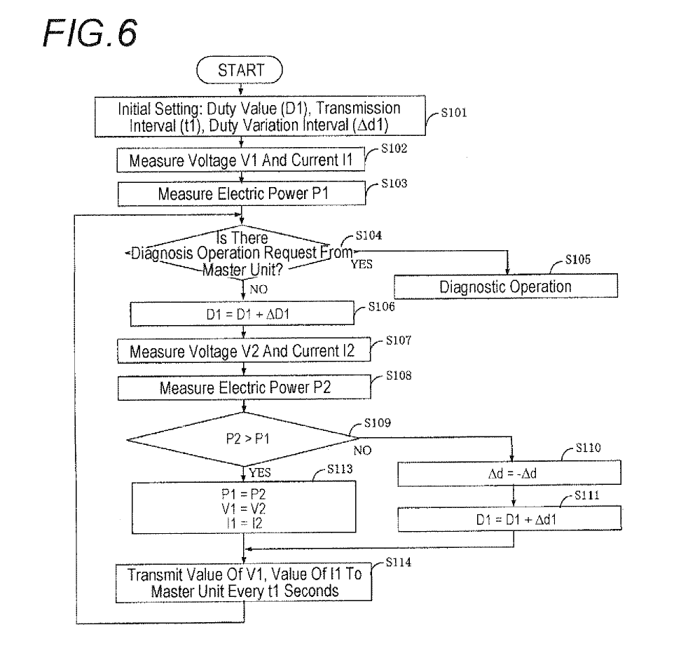

FIG. 6 is a flowchart showing a first example of operation achieved during fault diagnostic processing performed by the panel controller 20. FIG. 6 is presumed to perform fault diagnostic processing by utilization of respective operating points that shift during MPPT control.

First, the MPU 215 of the MPPT section 210 sets an initial value to each of variables (step S101). Specifically, the MPU 215 sets an initial value (e.g., 50%) to a variable D1 of a Duty value used for controlling the switch section 213S of the DC-DC converter 213. Further, the MPU 215 sets an initial value (e.g., one minute) to a variable t1 of a transmission interval. Moreover, the MPU 215 sets an initial value (e.g., 100%/1024) to a variable Δd1 of a change interval of a Duty value. The transmission interval represents an interval at which the panel controller 20 periodically transmits information about the I-V characteristic of the PV panel 10 to the panel controller 50. The Duty value can be changed in; for instance, 1024 steps.

Subsequently, the first voltage sensor 211 or the second voltage sensor 214 measures (detects) a voltage V1. The current sensor 212 measures (detects) an electric current I1 (step S102).

Incidentally, since the output side of the DC-DC converter 213 is presumed to be more affected by noise than is the input side of the DC-DC converter 213, the first detected voltage is preferable as a measured value.

The MPU 215 next calculates electric power P1 from the thus-measured voltage V1 and the thus-measured current I1 (step S103). The electric power P1 can be also measured (detected) by separately providing an electric power sensor.

Subsequently, a determination is made as to whether or not the MPU 215 received the diagnostic operation request from the panel controller 50 (step S104). The diagnostic operation request is received by the communication section 220. For instance, the power conditioner 40 transmits a diagnostic operation request to the panel controller 50 at initiation or reset of the power conditioner 40. The panel controller 50 transfers the diagnostic operation request to the panel controller 20.

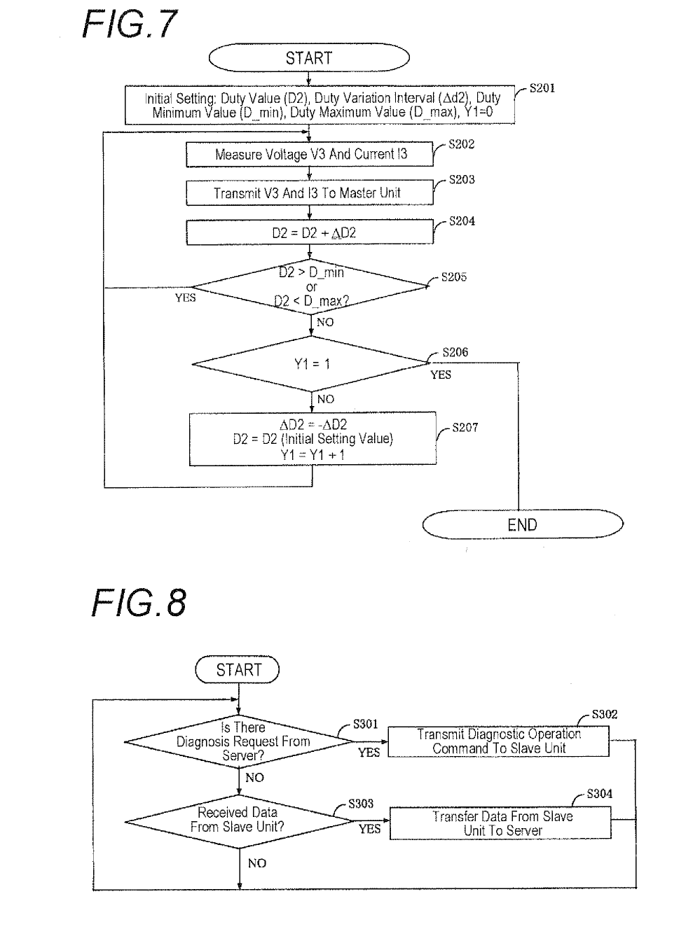

When received the diagnostic operation request from the communication section 220, the panel controller 20 performs fault diagnostic processing (step S105). Operation to be performed during fault diagnostic processing in response to the fault diagnosis commencement request will be described later by reference to FIG. 7. The diagnostic operation request is sometimes generated by the MPU 215 of the panel controller 20 for itself at predetermined timing.

When the panel controller 20 commences fault diagnostic processing pertaining to step S105, the MPU 215 changes the output range of the PV panel 10 to a second range that is broader than a first range. The first range is a range of operating points used in a first example of operation shown in FIG. 6, and the second range is a range of operating points used in a second example of operation shown in FIG. 7.

In the meantime, when the communication section 220 has not received the diagnostic operation request, the MPU 215 adds Δd1 to the Duty value D1. Specifically, D1←D1+Δd1 is generated (step S106), where symbol “←” (“=” in FIGS. 6 and 7) designates substitution.

The first voltage sensor 211 or the second voltage sensor 214 measures a voltage V2 acquired after the Duty value D1 was changed in step S106. The current sensor 212 measures a current I2 acquired after the Duty value D1 was changed in step S106 (step S107).

Subsequently, the MPU 215 calculates, from the thus-measured voltage V2 and the thus-measured electric current I2, electric power P2 acquired after the Duty value D1 was changed in step S106 (step S108). Incidentally, the electric power P2 can be also measured directly by additional provision of an electric power sensor.

The MPU 215 then determines whether or not the electric power P2 is greater than the electric power P1 (P2>P1) (step S109).

When P2>P1 stands, the MPU 215 handles the information measured this time as preceding information (step S110). For instance, the MPU 215 handles the electric power P2 measured this time as preceding electric power. Specifically P1←P2 is adopted. The MPU 215 also handles the voltage V2 measured this time as a preceding voltage. Specifically, V1←V2 is adopted. Furthermore, the MPU 215 handles the electric current I2 measured this time as a preceding electric current. Specifically, I1←I2 is adopted.

Namely, when P2>P1 stands, the electric power P1 measured last time is less than the electric power P2 measured this time. Hence, the MPU 215 determines that the operating point is successfully approaching the maximum operating point and makes a preparation for the next measurement while the direction of transition of the operating point is kept in the same direction.

Meanwhile, when P1=P2 stands, a positive or negative sign of the Duty change interval Δd1 is inverted (step S111). Specifically, Δd1←−Δd1 is adopted. Specifically, since the electric power P1 measured last time is the electric power P2 measured this time or more, the MPU 215 determines that the operating point passed by the maximum operating point, and changes the direction of transition of the operating point toward. the maximum operating point.

Subsequently, the MPU 215 adds the Δd1 whose positive or negative sign is inverted to the Duty value D1. Namely, D1←D1+Δd1 is adopted (step S112).

The communication section 220 transmits the value of the voltage V1 and the value of the current I1 to the panel controller 50 at each transmission interval t1 (step S113). The panel controller 50 can thereby manage information about the I-V characteristic in the neighborhood of the maximum operating point of the PV panel 10. The I-V characteristic is used for the server 60 to determine if the PV panel 10 is faulty.

After processing pertaining to step S 113, the panel controller 20 proceeds to step S104.

As shown in FIG. 6, when fault diagnostic processing is performed in conjunction with MPPT control, the shift range of the operating point is; for instance, a voltage range from 45(V) to 47(V) (a first range). The shift range is not limited to this range.

The fault diagnostic processing shown in FIG. 6 enables performance of fault diagnosis of the PV panel 10 by mere performance of MPPT control.

FIG. 7 is a flowchart showing a second example of operation of the panel controller 20 achieved during fault diagnostic processing. In FIG. 7, fault diagnostic processing is presumed to be performed in a voltage range that is broader than the range of the respective operating points which shift during MPPT control. FIG. 7 defines a voltage range in which the operating points are shifted.

First, the MPU 215 of the MPPT section 210 sets an initial value to each of the variables (step S201). Specifically, the MPU 215 sets an initial value (e.g., 50%) to a variable D2 of a Duty value. Further, the MPU 215 sets an initial value (e.g., 100%/1024) to a variable Δd2 of the change interval. of the Duty value. Further, the MPU 215 sets an initial value (e.g., 10%) to a variable D_min of the Duty value. The MPU 215 also sets an initial value (e.g., 90%) to a variable D_max of the maximum Duty value. The MPU 215 also sets an initial value “0” to the variable Y1.

The first voltage sensor 211 or the second voltage sensor 214 measures (detects) a voltage V3. The current sensor 212 measures (detects) the electric current I1 (step S202).

Subsequently, the communication section 220 transmits a value of the measured voltage V3 and a value of the measured electric current I3 to the panel controller 50 (step S203). Specifically, the communication section 220 transmits information about the I-V characteristic of the PV panel 10 acquired at an operating point of the voltage V3. Incidentally, the communication section 220 can also transmit the information with a smaller frequency rather than transmitting information each time the voltage V3 and the electric current I3 are measured. Moreover, the MPPT section 210 can also calculate an average of the voltages V3 measured a number of times and an average of the electric currents I3 measured a number of times, and the communication section 220 can transmit information about the averages.

The MPU 215 then adds Δd2 to the Duty value D2. Specifically, D2←D2+Δd2 is adopted (step S204).

The MPU 215 then determines if the Duty value D2 is larger than the Duty minimum value D_min. (D2>D_in) or if the Duty value D2 is smaller than the Duty maximum value D_max (D2<D_max) (step S205). Specifically, the MPU 215 determines if the requirement for D_min<D2<D_max is fulfilled.

When the requirement for D_min<D2<D_max is fulfilled, the MPU 215 determines that the Duty value stays within the voltage range where the duty value is shifted and also determines whether or not the variable Y1 is one (Y1=1) (step S206).

When Y1=1 does not stand, the MPU 215 inverts the positive or negative sign of the Duty change interval Δd2. Further, the MPU 215 resets the Duty value D2 to the initial value. The MPU 215 also adds one to the variable Y1. Specifically, Y1←Y1+1 is adopted (step S207).

Specifically, the MPU 215 determines that the Duty value first arrived at one end (either the Duty minimum value or the Duty maximum value) in the voltage range where the Duty value is shifted, and makes a preparation to change the Duty value to the other end.

After processing pertaining to step S207, the panel controller 20 proceeds to processing pertaining to step S202.

When Y1=1 stands, the panel controller 20 completes processing shown in FIG. 7. Specifically, the MPU 215 determines that the Duty value reached both the one end and the other end (both the Duty minimum value and the Duty maximum value) of the voltage range where the Duty value is shifted, and completes processing.

When fault diagnostic processing shown in FIG. 7 is performed, the shift range of the operating point is; for instance, a range from 20(V) to 55(V) (a second range). However, the shift range is not limited to this range.

By means of the fault diagnostic processing shown in FIG. 7, the I-V characteristics for respective operating points of the PV panel 10 can be acquired in a predetermined voltage range that is broader than the voltage range acquired when MPPT control is performed. Further, since information about the I-V characteristic is transmitted to the panel controller 50, the panel controller 50 can manage information about the I-V characteristic of the PV panel 10 belonging to the predetermined voltage range.

FIGS. 6 and 7 illustrate that the MPPT section 210 of the panel controller 20 performs both operations; namely, changing the operating point and sensor measurement. The power conditioner 40 can change the operating point instead, and the MPPT section 210 of the panel controller 20 can perform sensor measurement instead.

FIG. 8 is a flowchart showing an example of operation achieved during fault diagnostic operation performed by the panel controller 50. In FIG. 8, the CPU 422 of the communication section 420 of the panel controller 50 monitors communications conditions.

The CPU 422 of the communication section 420 determines whether or not the diagnostic operation request is received from the server 60 (step S301). When the diagnostic operation request is received, the communication section 420 transfers the diagnosis request operation to the panel controller 20 (step S302).

The CPU 422 determines whether or not data are received from the panel controller 20 (step S303). The data include, for instance, information about the I-V characteristic of the PV panel 10 acquired by the panel controller 20 during MPPT control or fault diagnostic processing. When the data are received from the panel controller 20, the communication section 220 transfers the data to the server 60 (step S304).

As above, in the panel controller 20 according to the embodiment, the MPPT section 210 has a function as a control section for controlling the output of the PV panel 10 within the first range. Moreover, the MPPT section 210 has a function of serving as an output range section that changes the range of the output of the PV panel 10 to the second range that is broader than the first range.

The output characteristic of the PV panel 10 can be searched over the output range of the PV panel 10 which is broader than that employed during MPPT control. Accordingly, fault diagnosis of the PV panel 10 can be easily performed. Further, fault diagnosis involves neither high-lift work nor risk. Further, fault diagnosis can be carried out by use of the module that performs common MPPT control, and hence a device specifically designed for fault diagnosis becomes obviated.

### Second Embodiment

A second embodiment provides an explanation about fault diagnostic processing (cooperative diagnostic processing) that is performed in a cooperative manner by the PV panels 10 belonging to the PV string 11. Since the photo voltaic system 1 according to the second embodiment is the same as that described in connection with the first embodiment in terms of a configuration, its explanations are omitted.

When one panel controller 20 in the PV string 11 performs fault diagnostic processing of a corresponding PV panel 10, output voltages of all of the panel controllers 20 in the PV string 11 are controlled so as to become constant during cooperative diagnostic processing. Although making the output voltages constant is exemplified in the embodiment, the output currents can be also made constant instead.

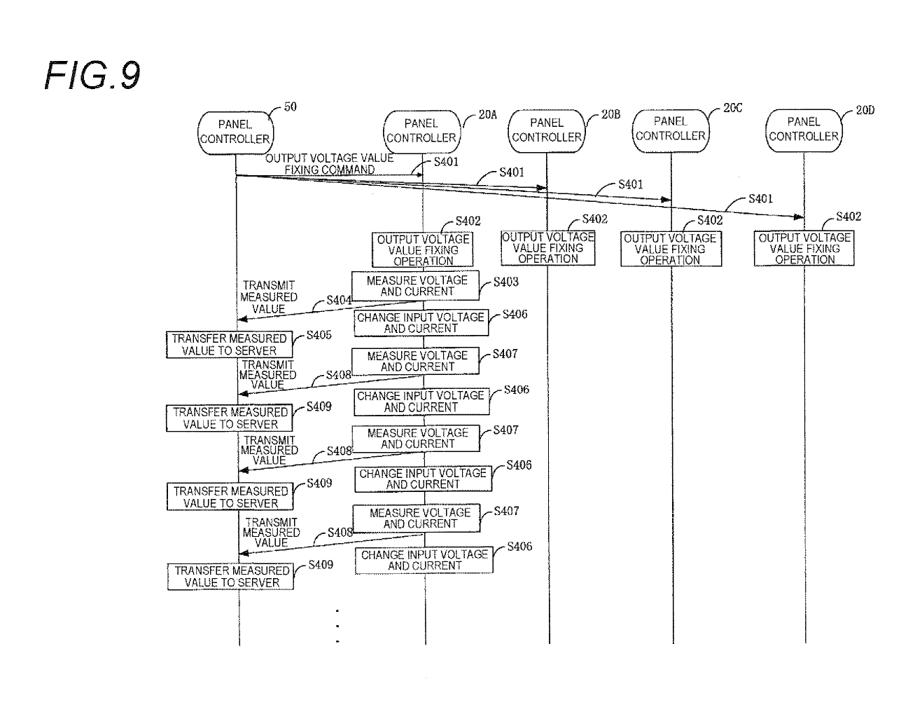

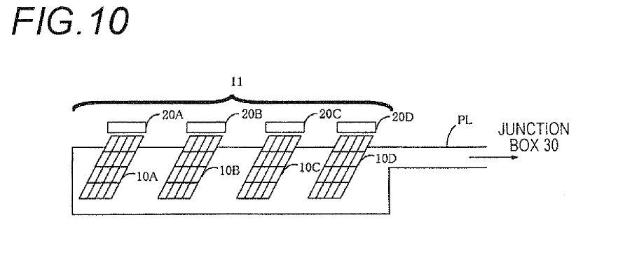

FIG. 9 is a sequence diagram showing an example of operation achieved during cooperative diagnostic processing performed in the photo voltaic system 1. In FIG. 9, performing cooperative diagnostic processing as fault diagnostic processing is presumed to be previously set. FIG. 10 is an enlarged view of surroundings of the PV string 11 shown in FIG. 1.

First, the CPU 422 of the communication section 420 of the panel controller 50 is assumed to detect a predetermined cooperative diagnostic operation and detect a diagnostic operation request for a PV panel 10A. The communication section 420 of the panel controller 50 transmits an output voltage value fixing command to all of the panel controllers 20 (20A to 20D) corresponding to the PV panels 10 (10A to 10D) in the PV string 11 to which the PV panel 10A belongs (step S401). The output voltage value fixing command is a control signal for the purpose of making the output voltages of all of the panel controllers 20 constant.

In the respective panel controllers 20 (20A to 20D), when the communication section 220 receives the output voltage value fixing command from the panel controller 50, the MPPT section 210 performs output voltage value fixing operation (step S402). Specifically, in order to make the output voltage of the panel controller 20 constant, the MPU 215 monitors the output value of the second voltage sensor and performs control so as to make the second detected voltage constant. Even when the second detected voltage is maintained constant, the first detected voltage and the second detected voltage are variable. The output voltage value fixing operation is performed not only in connection with the panel controller 20A but also in connection with the other panel controls 20B to 20D, as well.

Subsequently, in the panel controller 20A, the first voltage sensor 211 measures the first detected voltage at the first operating point of the PV panel 10A, and the current sensor 212 also measures the first detected current (step S403). The first operating point is determined from; for instance, the initial value of the Duty value employed by the MPU 215 in FIGS. 6 and 7.

The communication section 220 of the panel controller 20A next transmits information about the measured voltage value and the measured current value (the measured values) to the panel controller 50 (step S404). The measured values are equivalent to information about the I-V characteristic acquired at the first operating point of the PV panel 10.

The communication section 420 of the panel controller 50 transfers the information about the measured values from the panel controller 20A to the server 60 (step S405). The server 60 receives the information about the measured values from the panel controller 50 and stores the information in itself.

After having completed measurement at the previous operating point (e.g., measurement pertaining to step S403), the panel controller 20A changes the operating point to the next operating point. Specifically, the MPU 215 changes the Duty value, thereby changing the input voltage and the input current for the panel controller 20A (step S406).

In the panel controller 20A, the first voltage sensor 211 measures the first detected voltage at the changed operating point of the PV panel 10A, and the current sensor 212 also measures the first detected current (step S407).

The communication section 220 of the panel controller 20A transmits information about the measured voltage value and the measured current value (measured values) to the panel controller 50 (step S408). The measured values are equivalent to information about the I-V characteristic of the PV panel 10 acquired at the changed operation point.

The communication section 420 of the panel controller 50 transfer the information about the measured values from the panel controller 20A to the server 60 (step S409). The server 60 receives the information about the measured values from the panel controller 50 and stores the information in itself.

Processing pertaining to steps S406 to S409 is iterated in subsequent operation. The server 60 can thereby store information about the I-V characteristics of the PV panel 10A at the respective operation points. The server 60 therefore can determine if the PV panel 10A is faulty.

As above, the MPPT section 210 of the panel controller 20 controls the outputs of the PV panel 10 while the DC output of the DC-DC converter 213 is controlled so as to stay constant. Further, the panel controller 20 performs in cooperation with the other panel controllers 20 such that the DC outputs of the DC-DC converters 213 of all of the panel controllers 20 become identical with each other.

According to cooperative diagnostic processing shown in FIG. 9, even when the operating point is changed during fault diagnostic processing of the PV panel 10A, electrical loads imposed on the other PV panels 10B to 10D belonging to the PV string 11 become constant. Consequently, fault diagnostic processing can be performed without electrically affecting the other PV panels 10B to 10D.

The present invention is not limited to the configuration according to the embodiment. Any configurations can be applied to the present invention, so long as the functions described in connection with claims or the functions yielded by the configurations described in connection with the embodiments can be accomplished.

In the embodiment, the power conditioner 40 and the panel controller 50 can be also provided as separate devices. In this case, when the MPPT section 410 of the power conditioner 40 is not used for MPPT control and the fault diagnostic processing, the MPPT section 410 can be omitted. The configuration of the power conditioner 40 can thereby be simplified.

In the embodiment, the plurality of PV panels 10 can be also connected in parallel to each other, to thus make up the PV string. As a result, even when the generated electric current is decreased under influence of a shade of the predetermined PV panel 10, influence on the other PV panels 10 can be prevented.

In the embodiment, a battery can be also set in place of the power conditioner 40. Generated electrical power can be temporarily stored rather than being provided indoors instantly.

In the embodiment, the panel controller 20 can be also equipped with a DC-AC converter in a stage subsequent to the MPPT section 210 and convert generated electrical power into AC electrical power. The power conditioner 40 that performs DC-AC conversion can thereby be omitted, and the configuration of the photo voltaic system 1 can be simplified correspondingly. Moreover, AC power is transmitted through the power lines PI, a power loss can be diminished.

In the embodiment, the panel controller 50 can store information about fault diagnostic processing and determine if the PV panel 10 is faulty in place of the server 60.

A first aspect provides an electricity generation controller for controlling an electrical energy production of a photo voltaic panel, the electricity generation controller including: a control section that controls an output of the photo voltaic panel within a first range; a signal processing section that processes a predetermined signal; and an output range change section that changes an output range of the photo voltaic panel controlled by the control section from the first range to a second range in accordance with the predetermined signal processed by the signal processing section, wherein the second range is broader than the first range.

The configuration makes it possible to search for an output characteristic of the photo voltaic panel in an output range of the photo voltaic panel which is broader than that achieved during normal operation (e.g., operation of Maximum Power Point Tracking (MPPT control)). Accordingly, a fault diagnosis of the photo voltaic panel can be readily performed. Moreover, fault diagnosis involves neither high-lift work nor danger. Further, fault diagnosis can be carried out by use of for instance, the control section that performs MPPT control, and hence a device specifically designed for fault diagnosis becomes obviated.

The electricity generation controller may be configured so that the output of the photo voltaic panel includes at least one of an output voltage and an output current of the photo voltaic panel.

The configuration makes it possible to easily perform fault diagnosis on the basis of the output voltage or the output current of the photo voltaic panel.

The electricity generation controller may further include: a voltage measurement section that measures the output voltage of the photo voltaic panel; a current measurement section that measures the output current of the photo voltaic panel; and a transmission section that transmits power generation information on the photo voltaic panel in accordance with a measurement result of the voltage measurement section and the current measurement section.

The configuration enables; for instance, another device, to store and analyze power generation information on the photo voltaic panel. Therefore, the other device can determine if the photo voltaic panel is faulty.

The electricity generation controller may be also configured so that the control section includes a DC conversion section that receives the output of the photo voltaic panel as a DC input, subject the input to DC conversion, and produces a DC output, and the control section controls the output of the photo voltaic panel in a state where the DC output of the DC conversion section is controlled to be constant.

The configuration makes it possible to easily perform fault diagnosis without electrically affecting another PV panel.

The electricity generation controller may be also configured so that the output of the DC conversion section includes at least one of an output voltage and an output current of the DC conversion section.

The configuration makes it possible to perform fault diagnosis of the photo voltaic panel while at least either the output voltage or the output current of the DC conversion section is made constant.

The electricity generation controller may be also configured so that the control section controls the DC output of the DC conversion section to be constant and identical with a DC output of a DC conversion section provided in another electricity generation controller that controls an electrical energy production of another photo voltaic panel that is different from the photo voltaic panel of the electricity generation controller.

The configuration enables the electricity generation controller and another electricity generation controller to perform fault diagnosis in a cooperative manner without electrically affecting each other. Accordingly, accuracy of fault diagnosis is enhanced.

The electricity generation controller may be also configured so that the predetermined signal includes a diagnostic operation request signal for requesting diagnostic operation for determining if the photo voltaic panel, is faulty.

The configuration makes it possible to perform fault diagnosis in response to; for instance, user's actuation of the electricity generation controller with a button, scheduling of diagnostic operation, or a diagnostic operation request from another device.

A second aspect provides an electricity generation control system including a plurality of electricity generation controllers for controlling electrical energy productions of a plurality of serial- or parallel-connected photo voltaic panels, wherein each of the electricity generation controllers includes: a control section that controls an output of the photo voltaic panel within a first range; a signal processing section that processes a predetermined signal; and an output range change section that changes an output range of the photo voltaic panel controlled by the control section from the first range to a second range in accordance with the predetermined signal processed by the signal processing section, wherein the second range is broader than the first range.

The configuration makes it possible to search for an output characteristic of the photo voltaic panel in an output range of the photo voltaic panel which is broader than that achieved during normal operation (e.g., operation of Maximum Power Point Tracking (MDPT control)). Accordingly, a fault diagnosis of the photo voltaic panel can be readily performed. Moreover, fault diagnosis involves neither high-lift work nor danger. Further, fault diagnosis can be carried out by use of for instance, the control section that performs MPPT control, and hence a device specifically designed for fault diagnosis becomes obviated.

The electricity generation control system may be configured so that the control section of each of the electricity generation controllers includes a DC conversion section that receives the output of the photo voltaic panel as a DC input, subjects the input to DC conversion, and produces a DC output, and the control section of each of the electricity generation controllers controls the output of the photo voltaic panel while controlling the DC output of the DC conversion section to be constant and identical with the DC output of the DC conversion section of other electricity generation controller.

The configuration enables the electricity generation controllers in the electricity generation system to perform fault diagnosis in a cooperative manner without electrically affecting each other. Accordingly, accuracy of fault diagnosis is enhanced.

A third aspect provides an electricity generation control method for controlling an electrical energy production of a photo voltaic panel, the method including: controlling an output of the photo voltaic panel within a first range; processing a predetermined signal; and changing an output range of the photo voltaic panel from the first range to a second range in accordance with the processed predetermined signal, wherein the second range is broader than the first range.

The method makes it possible to search for an output characteristic of the photo voltaic panel in an output range of the photo voltaic panel which is broader than that achieved during normal operation (e.g., operation of Maximum Power Point Tracking (MPPT control)). Accordingly, a fault diagnosis of the photo voltaic panel can be readily performed. Moreover, fault diagnosis involves neither high-lift work nor danger. Further, fault diagnosis can be carried out by use of; for instance, the control section that performs MPPT control, and hence a device specifically designed for fault diagnosis becomes obviated.

The present application is based upon and claims the benefit of Japanese patent application No. 2012-053534 filed on Mar. 9, 2012, the contents of which are incorporated by reference in its entirety.

What is claimed is:

1. An electricity generation controller for controlling an electrical energy production of a photo voltaic panel, the electricity generation controller comprising:
a control section that controls an output of the photo voltaic panel within a first range;
a signal processing section that processes a predetermined signal; and
an output range change section that changes an output range of the photo voltaic panel controlled by the control section from the first range to a second range in accordance with the predetermined signal processed by the signal processing section, wherein the second range is broader than the first range.

2. The electricity generation controller according to claim 1, wherein
the output of the photo voltaic panel includes at least one of an output voltage and an output current of the photo voltaic panel.

3. The electricity generation controller according to claim 2, further comprising:
a voltage measurement section that measures the output voltage of the photo voltaic panel;
a current measurement section that measures the output current of the photo voltaic panel; and
a transmission section that transmits power generation information on the photo voltaic panel in accordance with a measurement result of the voltage measurement section and the current measurement section.

4. The electricity generation controller according to claim 1, wherein
the control section includes a DC conversion section that receives the output of the photo voltaic panel as a DC input, subject the input to DC conversion, and produces a DC output, and
the control section controls the output of the photo voltaic panel in a state where the DC output of the DC conversion section is controlled to be constant.

5. The electricity generation controller according to claim 4, wherein
the output of the DC conversion section includes at least one of an output voltage and an output current of the DC conversion section.

6. The electricity generation controller according to claim 5, wherein
the control section controls the DC output of the DC conversion section to be constant and identical with a DC output of a DC conversion section provided in another electricity generation controller that controls an electrical energy production of another photo voltaic panel that is different from the photo voltaic panel of the electricity generation controller.

7. The electricity generation controller according to claim 1, wherein
the predetermined signal includes a diagnostic operation request signal for requesting diagnostic operation for determining if the photo voltaic panel is faulty.

8. An electricity generation control system including a plurality of electricity generation controllers for controlling electrical energy productions of a plurality of serial- or parallel-connected photo voltaic panels,
each of the electricity generation controllers comprising:
a control section that controls an output of the photo voltaic panel within a first range;
a signal processing section that processes a predetermined signal; and
an output range change section that changes an output range of the photo voltaic panel controlled by the control section from the first range to a second range in accordance with the predetermined signal processed by the signal processing section, wherein the second range is broader than the first range.

9. The electricity generation control system according to claim 8, wherein
the control section of each of the electricity generation controllers includes a DC conversion section that receives the output of the photo voltaic panel as a DC input, subjects the input to DC conversion, and produces a DC output, and
the control section of each of the electricity generation controllers controls the output of the photo voltaic panel while controlling the DC output of the DC conversion section to be constant and identical with the DC output of the DC conversion section of other electricity generation controller.

10. An electricity generation control method for controlling an electrical energy production of a photo voltaic panel, the method comprising:
controlling an output of the photo voltaic panel within a first range;
processing a predetermined signal; and
changing an output range of the photo voltaic panel from the first range to a second range in accordance with the processed predetermined signal, wherein the second range is broader than the first range.
